(19) United States
(12) Patent Application Publication
(10) Pub. No.: US 2005/0102429 A1
(43) Pub. Date: May 12, 2005

(54) Portal cluster manager

(75) Inventors: Yaacov Pinhas, Haifa (IL); Gilad Menashe, Tel-Mond (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SAP AG, Walldorf (DE)

(21) Appl. No.: 10/703,849

(22) Filed: Nov. 6, 2003

(51) Int. Cl. G06F 15/16

(52) U.S. Cl. 709/248

(57) ABSTRACT

A method for managing a plurality of servers includes launching a cluster manger in response to a request from a user. The cluster manager is operable to manage system preference settings of a plurality of servers in a cluster group. A first server is selected from the plurality of servers provided in the cluster group according to an input from the user. The selected first server is designated to be a master server. A new system preference setting for the first server is receiving from the user. A second server from the plurality of server provided in the cluster group is selected according to an input from the user. A system preference setting of the second server is synchronized to the new system preference setting of the first server according to an input from the user.

### BACKGROUND OF THE INVENTION

The present invention relates to a distributed computer system and management thereof.

Computers have now become an integral part of our society both in business and personal lives. Almost every business of sufficient size in the United States and other developed countries have one or more computers to assist them in running their businesses. Similarly, most families in the United States now have one or more computers at home that are used to run various applications as well as playing games.

Some attribute the popularity of the computers to the Internet. The Internet provides people with a ready access to vast amounts of data. Many people now get their news, sports, stock, entertainment, and other information primarily from the Internet.

The businesses have also embraced the Internet. The Internet provides the opportunity for computers to communicate instantly with other computers or individuals. Business processes that were once restricted to intranets and their users are now moving to the Internet. Accordingly, companies are moving more and more of their data to electronic forms. In addition, companies have amassed huge amounts of data in an effort to understand their business, improve performance, and build stronger employee, customer, and partner relationships.

Today distributed computer systems are widely used by various organizations to accommodate the ever increasing demand for the computer resources from consumers and businesses alike. Servers are grouped or clustered to perform certain functions. That is, Web servers are grouped into a first group, and unification servers are grouped into a second group, and so on. Accordingly, each distributed system generally has a plurality of groups of servers. One example of such a distributed system is the enterprise portal system of SAP AG, a German software company. Such a portal system includes servers that primary perform functions relating to presentation of data (or first server cluster) and servers that primary execute business applications (or second server cluster). As the importance of server clusters increases, the businesses are becoming more aware of the need to more efficiently managing these server clusters.

### BRIEF SUMMARY OF THE INVENTION

In one embodiment, a method for managing a plurality of servers includes launching a cluster manger in response to a request from a user. The cluster manager is operable to manage system preference settings of a plurality of servers in a cluster group. A first server is selected from the plurality of servers provided in the cluster group according to an input from the user. The selected first server is designated to be a master server. A new system preference setting for the first server is receiving from the user. A second server from the plurality of server provided in the cluster group is selected according to an input from the user. A system preference setting of the second server is synchronized to the new system preference setting of the first server according to an input from the user.

In one embodiment, a method for managing a plurality of servers in a portal environment includes selecting a first server from the plurality of servers provided in a cluster group, the selected first server being designated to be a master server; changing a system preference setting of the first server, the changed system preference setting being a new system preference setting for the first server; selecting a second server from the plurality of server provided in the cluster group; synchronizing a system preference setting of the second server to the new system preference setting of the first server; and applying the synchronized system preference setting to the second server.

In another embodiment, a computer system having a plurality of servers includes means for launching a cluster manger in response to a request from a user, the cluster manager being operable to manage system preference settings of a plurality of servers in a cluster group; means for selecting a first server from the plurality of servers provided in the cluster group according to an input from the user, the selected first server being designated to be a master server; means for receiving a new system preference setting for the first server from the user; means for selecting a second server from the plurality of server provided in the cluster group according to an input from the user; and means for synchronizing a system preference setting of the second server to the new system preference setting of the first server according to an input from the user.

In yet another embodiment, a computer readable medium includes a computer program operable to manage system preference settings of a plurality of server provided in a cluster group. The computer program includes code for selecting a first server from the plurality of servers provided in the cluster group according to an input from a user, the selected first server being designated to be a master server; code for receiving a new system preference setting for the first server from the user; code for selecting a second server from the plurality of server provided in the cluster group according to an input from the user; and code for synchronizing a system preference setting of the second server to the new system preference setting of the first server according to an input from the user.

### BRIEF DESCRIPTION OF THE DRAWINGS

FIG. 1A illustrates a client-server system including a presentation layer, an application layer, and a database layer according to one embodiment of the present invention

FIG. 1B illustrates a schematic interactions between the three functional layers of FIG. 1A.

FIG. 2 illustrates an enterprise portal that couples a client to a plurality of information sources according to one embodiment of the present invention.

FIG. 3 illustrates a process for updating the system preferences for servers in a given cluster group according to one embodiment of the present invention.

FIG. 4 illustrates a main user interface page of a portal cluster manger according to one embodiment of the present invention.

FIG. 5 illustrates a log file of a server in a portal cluster group according to one embodiment of the present invention.

FIGS. 6A-6C illustrate exemplary screen shots relating to synchronization of a sever to the master settings according to one embodiment of the present invention.

FIGS. 7A and 7B illustrate exemplary screen shots relating to restarting a server in a portal cluster group using a restart button provided on the main user interface page of the FIG. 4.

FIG. 8 illustrates an exemplary screen shot for adding a server to a cluster group according to one embodiment of the present invention.

FIG. 9 illustrates an exemplary screen shot for editing a server in a cluster group according to one embodiment of the present invention.

FIG. 10 illustrates an exemplary screen shot for removing a server from a cluster group according to one embodiment of the present invention.

FIG. 11A illustrates a system preference page according to one embodiment of the present invention.

FIG. 11B illustrates an XML file used to launch the system preference page of FIG. 11A according to one embodiment of the present invention.

FIG. 12 illustrates an exemplary screen shot providing a portal host server list.

FIG. 13 illustrates a system preference page that has been provided with new settings according to one embodiment of the present invention.

### DETAILED DESCRIPTION OF THE INVENTION

Embodiments of the present invention relate a distributed computer system and management thereof. The present invention is described in terms of portal servers for illustrative purposely only. Accordingly, the present invention is not limited to the portal system and may be implemented with any computer system having a plurality of computers that are linked together in one or more networks.

A portal serves as a gateway to information sources to one or more users. By definition, the portal is provided in a client-server environment or system that distributes the workload of a computer application across a plurality of cooperating computer programs. This type of computing separates user-oriented tasks, application tasks, and data management tasks. That is, these three types of tasks or functions are distributed to different layers: the presentation, application, and database layers. Generally, each layer has one or more software programs dedicated to provide services to their respective layers.

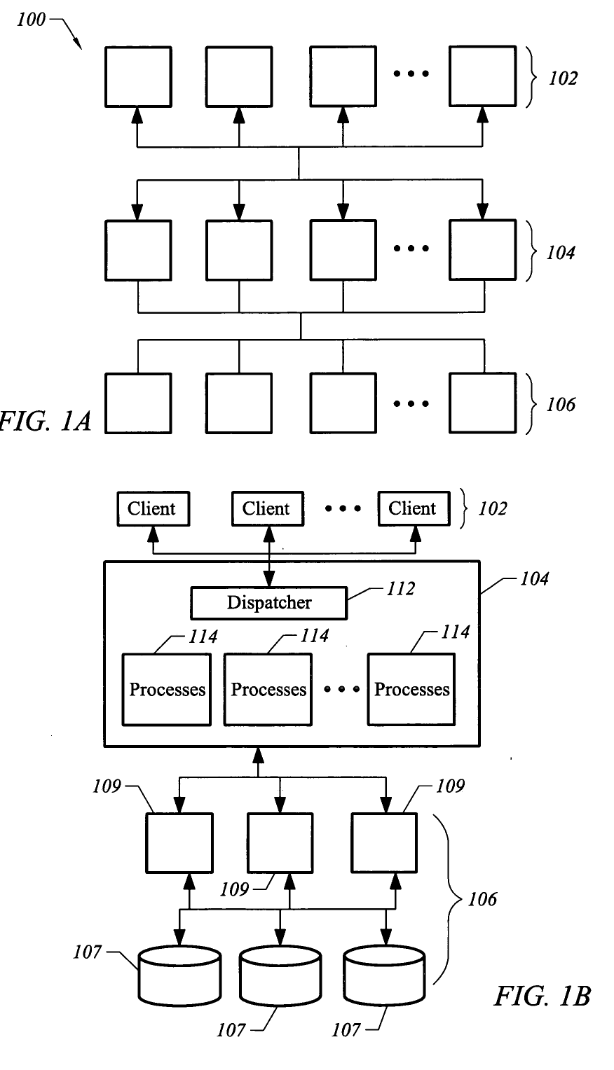

FIG. 1A illustrates a client-server system 100 including a presentation layer 102, an application layer 104, and a database layer 106 according to one embodiment of the present invention. Each layer has one or more servers that are primarily dedicated to provide functions relating to that layer. The system 100 illustrates a three-tier client-server system; however, a two-tier client-server system or multi-layer cooperative client-server system may also be used to implement the embodiments of the present invention.

The above three layers represent functional groups in the system 100. Each group is configured to support the demands of its functions. The database layer includes database servers that are primarily utilized to read or write data to and from storage locations. These storage locations may be provided in one or more storage subsystems that are linked to the database servers via a communication network, e.g., network attached storage (NAS) or storage area network (SAN). The application layer includes servers that contain the processing logic of the system, including services such as spooling, dispatching user requests, and formatting data. The presentation layer has servers that are primarily configured to perform tasks relating to presentation of the data. Each of these layers generally handle data differently so interfaces are needed to facilitate communication among them. Application layer serves as an intermediary between the presentation and database layers. The application layer and database layer, in turn, communicates with each via a middleware.

FIG. 1B illustrates a schematic interactions between the three functional layers. In the present embodiment, the application layer is implemented using SAP R/3. The application layer 104 receives the data or requests inputted by users using client systems, which are part of the presentation layer 102. The data received is converted to a format that is compatible with the application logic residing in the application layer. The data is then sent to a dispatcher 112.

The dispatcher is a control program that manages the resources of the applications residing in the application layer. The dispatcher initially keeps the requests in queues and processes them one by one. The dispatcher sends the requests to those work processes 114 that have sufficient resources to handle the requests. The work processes are services offered by the application servers (or services requested by a client).

Each work process executes the received request. This may involve accessing a database 107 in the database layer 106 to retrieve needed data. As understood by those skilled in the art, he database layer 106 generally includes a plurality of databases 107 and a plurality of database servers 109. Once the request has been executed, the work process sends resulting data to the dispatcher that, in turn, forwards it to the presentation server. The work process generally transforms the data received from the database 107 using application logic. Upon received the transformed or processed data, the presentation layer displays the data in a user-friendly format.

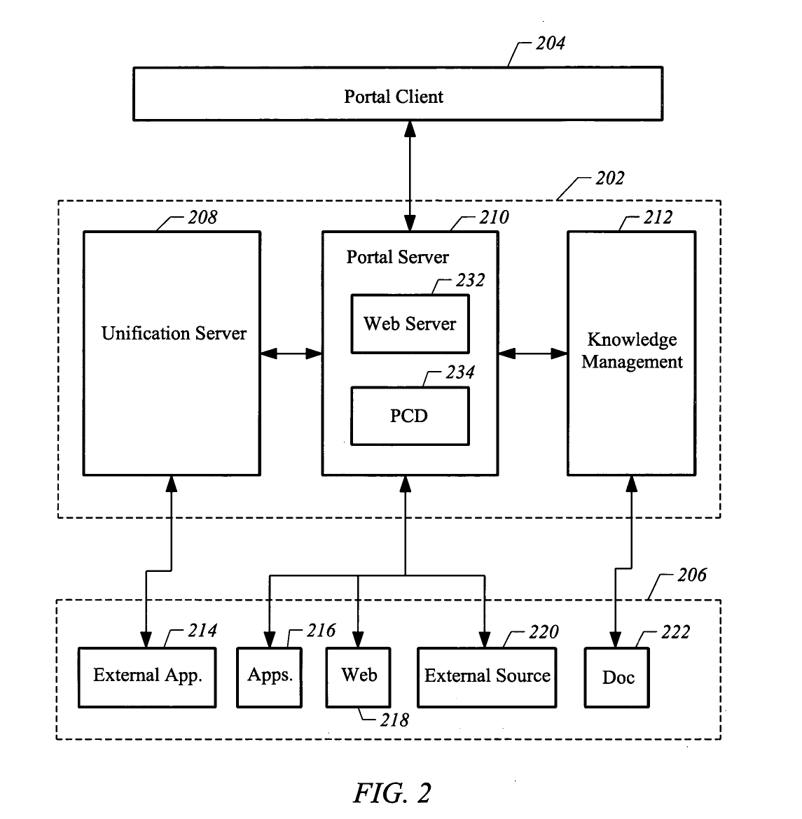

FIG. 2 illustrates an enterprise portal 202 that couples a client 204 to a plurality of information sources 206 according to one embodiment of the present invention. The client 204 may be a personal computer (PC) that is linked to the portal 202 via the Internet, intranet, wide area network, local area network, or the like. The portal is configured to provide users with a common entryway to various applications and information.

In the present embodiment, the portal 202 integrates a plurality of different technologies, enabling users to access applications and information that are both internal and external to the enterprise. The information sources 206 include an external application 214, internal application 216, external document source 218, internal document source 220, and Web 222.

The portal includes a unification server 208, a portal server 210, and a knowledge management 212. The unification server is configured to provide a business unification layer that enables dynamic integration of both applications and information from various sources. The business unification layer enables the creation of a unified object model, so that a portal user may dynamically integrate applications and information. Logical business objects, provided in component systems, are used to create a unification object model that is stored in a repository. The objects are mapped to each other by links, so that users are able to dynamically pass content from one information source to another.

The logical business objects are used to represent a thing, concept, process or event in operation, management, planning or accounting of an organization. Each busines object specify attributes, relationships, and actions/events. For example, the business objects may be used to represent purchase orders, vendors, and users of a system.

The portal server includes a web server 232 that communicates with the client and a portal content directory (PCD) 234 that includes a plurality of presentation components, e.g., iViews. The PCD is a file-based directory that also includes roles and the systems with which the portal is to interact. In one implementation, the PCD runs on a Java 2 Enterprise Edition™-compliant application server.

The knowledge management (KM) 210 is a set of services for managing knowledge and collaboration. The KM 210 provides a platform to harmonize various business tools under one business management platform regardless of the physical location of data. In one implementation, the KM includes a repository framework that manages the content of documents and corresponding document attributes, classification engine that organizes contents in folder or tree structures, and other components for managing information.

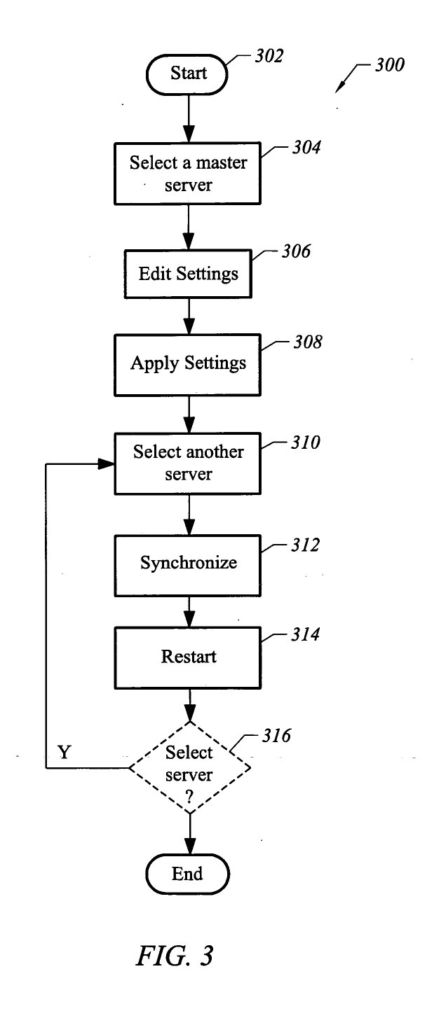

FIG. 3 illustrates a process 300 for changing preference settings using a portal cluster manager according to one embodiment of the present invention. At a step 302, the portal cluster manager is launched by a network administrator who wishes to change preference settings for servers in a cluster. These servers may be associated with the presentation layer, application layer, or database layer. In one embodiment, the portal cluster manager is launched by pressing a Cluster Manager button on a portal system preference page. The system preference page or screen is available from any portal client.

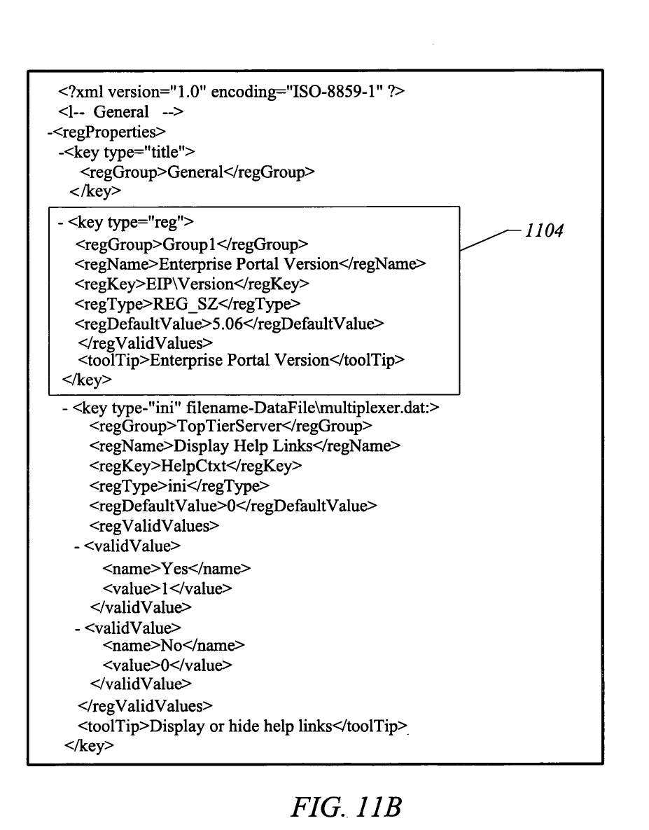

FIG. 11A illustrates a system preference page 1102 according to one embodiment of the present invention. The system preference page 1102 displays the current system settings and values. The page 1102 results from executing an XML file 1104 (FIG. 11B) and retrieving “*.ini files,” “*.properties files,” and “*.dat files” from the windows registry and also retrieving metabase files from the Internet Information Server registry files.

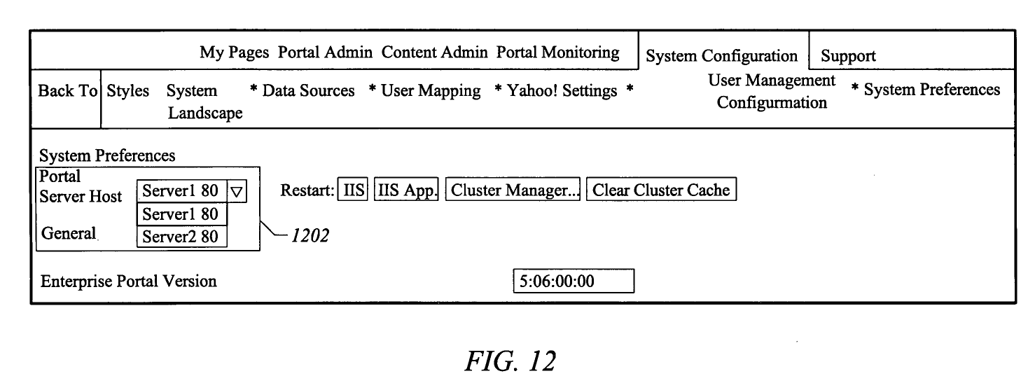

A master server is selected from a portal server host dropdown list 1202, as shown in FIG. 12 (step 304). The portal server host list displays all servers within a given cluster group. Any server in the cluster group may be selected as the master server. The selected server is the master server for that particular session and its setting field 412 indicates this with the following: “Master Settings.” Different servers may be selected as the master servers for subsequent sessions. In one embodiment, the selected server is made the default master server for the subsequent sessions, where the default master server may be unselected if the administrator so wishes.

This capability of allowing the administrator to select different master servers for different sessions enables the administrator to choose a server that is likely to least impact the entire system if the selected server crashes due to the input of new settings or is taken off-line during the preference update. For example, the administrator may not want to choose a given server as the master server for a given session performed at the end of the month if he know that server is heavily used by the accounting department for the monthly payroll functions.

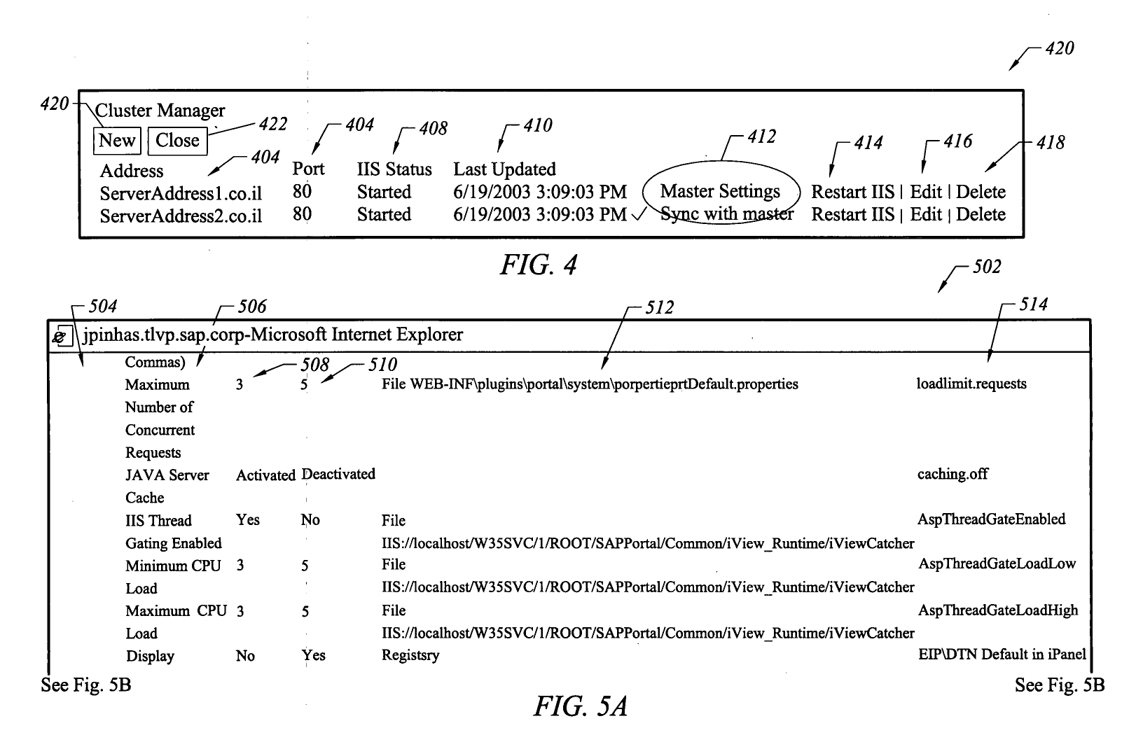

A main user interface 402 (FIG. 4) is displayed with a selected server 401 as being the “Master Server.” The UI 402 lists all the servers for that cluster group. If the cluster group has too many servers to fit within a single screen, a scrolling feature button may be provided with the main UI.

The main UI 402 is generated by retrieving a cluster group table from a lock server. The cluster group table includes address and port information of each of the servers in a given cluster group to which the table is assigned. The lock server may be a dedicated lock server or one of the servers in the cluster that process client requests as well as serve as the lock server.

The main UI 402 includes an address field 404, a port field 406, a status field 408, an update field 410, and a setting field 412. The address field lists the address of a given server. The port field lists a port to which a given server is coupled. Generally, each port services a plurality of servers. A server can be uniquely identified by using the address and port information.

The status field 408 indicates the status of a given server, e.g., “started,” “stopped,” and “unavailable.” The update field 410 indicates the time and date that a given server was last updated with a new preference setting. The setting field 412 indicates whether a given server has been selected as a master server or has been synchronized with the master server. The setting field also provides information as to whether or not the new settings have been applied after the synchronization.

The main UI 402 also includes a restart button 414, an edit button 416, and a delete button. 418, a new button 420, and a close button 422. Pressing the restart button 414 of a given server causes that server to restart and apply the new setting to the server. The edit button is used to edit the information about the server. The delete button is used to remove the server from that cluster group. The new button is used to add a new server to the cluster group. The close button 422 is used to end the cluster manager session.

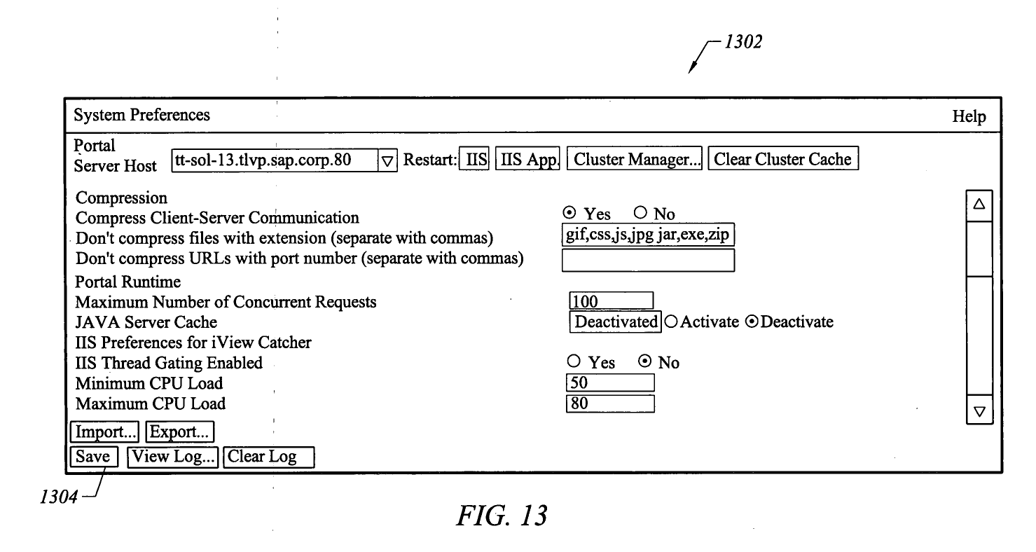

Referring back to the process 300, the administrator edits the preference setting of the selected server (step 306). The edits may relate to maximum number of concurrent requests that may be handled by the server, minimum CPU load, maximum CPU load, display help links, and the like. The edits to the settings are saved in a temporary file. FIG. 13 illustrates a system preference page 1302 that has been provided with new settings.

Once the new setting values have been inputted, they are applied to the master server (step 308). This is done by pressing a save button 1304 (FIG. 13). When the button is pressed, a delta compare is performed between the temporary file and the existing setting values in a preference setting file. The preference setting file is updated with the new values or the delta from the comparison.

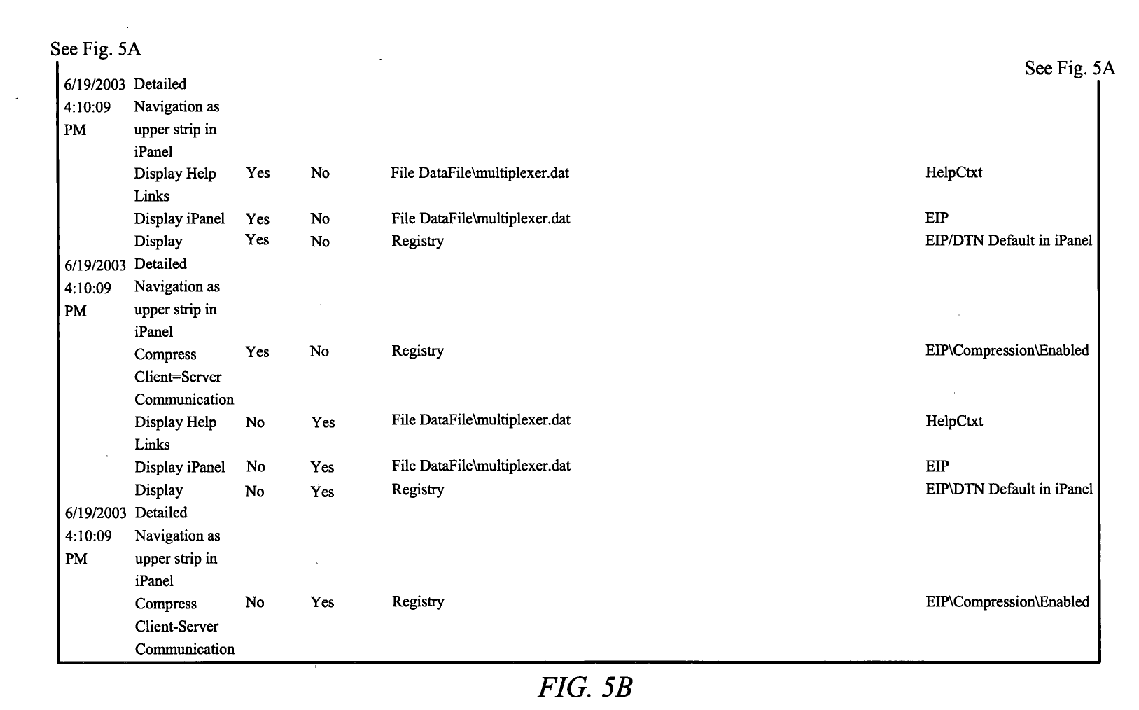

At this time, a log file 502 of the master server is updated to indicate the changes made (see FIG. 5). Each server has a log file to provide information about the updates to its settings. The log file 502 includes a date field 504 to indicate the date and time of the update, a description field 506 to describe the updated setting, an old value field 508 to indicate the value prior to the update, a new value field 510 to indicate the value after the update.

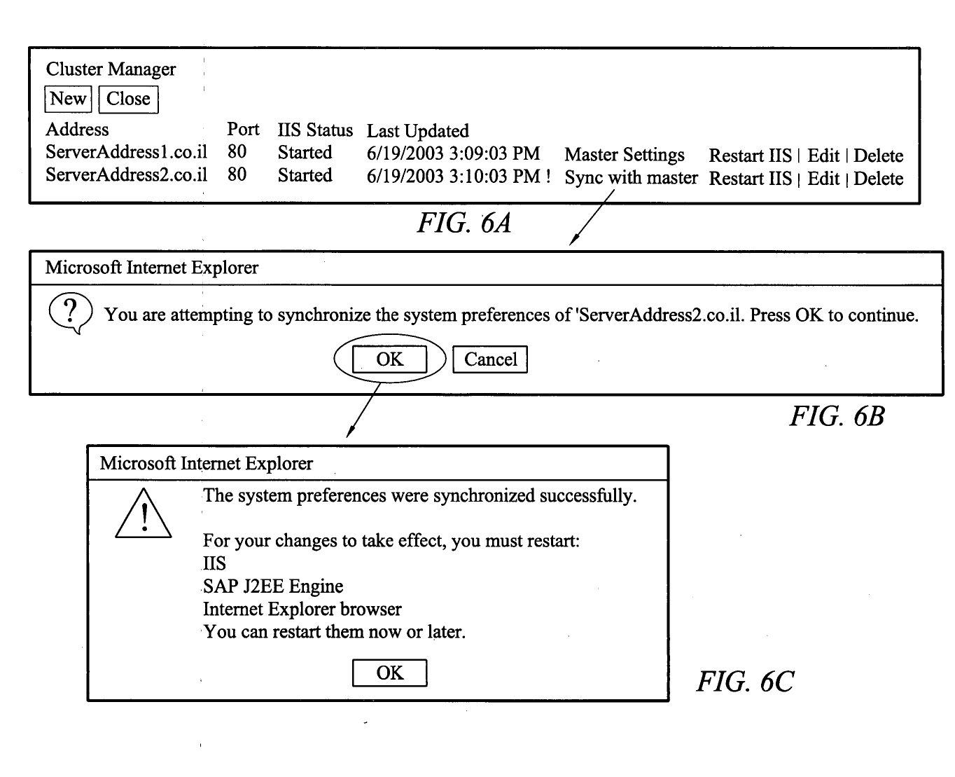

A server, e.g., server 403, to be synchronized with the master server is selected using the setting field/button 412 of the UI 402 (steps 310 and 312). Pressing of the “Sync with master” button 412 causes the delta value from the temporary file of the master server to be copied onto the system preference file of the serve 403. FIGS. 6A, 6B, and 6C illustrate exemplary screen shots relating to steps 310 and 312.

In the present embodiment, steps 310 and 312 may be considered as a single step. A check mark in the field 412 indicates that the new setting has been applied. An exclamation mark indicates that the server has not been synchronized with the new settings of the master server.

The new system preference is applied to the server 403 by pressing the “Restart” button 414 corresponding to the server 403 (step 314). Pressing the button causes a restart command to be generated. The address and port information of the server 403 is attached to the restart command. In the present embodiment, the synchronization and rebooting of the selected server 403 may be done using the buttons provided on the same page.

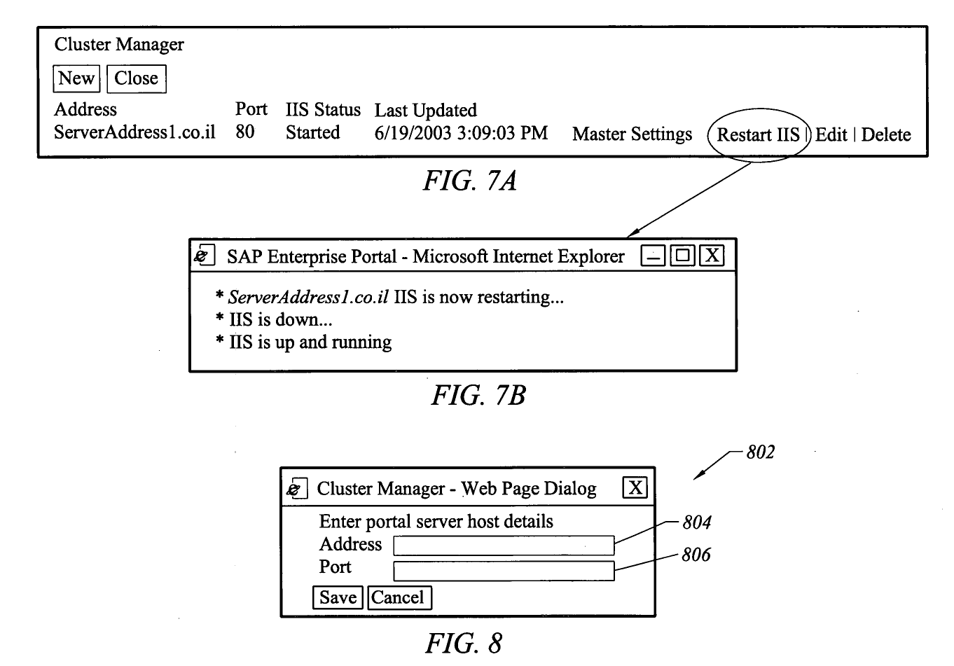

The server 403 reboots itself upon receiving the restart command (step 314). FIGS. 7A and 7B illustrate exemplary screen shots during step 314. Once rebooted, the new system preference is applied to the server 403. The log file of the server 403 is updated (see FIG. 5).

The process 300 returns to step 310 if the administrator selects another server to be synchronized. Otherwise, the process ends. In the present embodiment, the synchronization and restart steps 312 and 314 are performed one server at a time, so that only one server is taken offline at a time. In another embodiment, the administrator may select to have these steps performed with two or more servers at a time.

FIG. 8 illustrates a dialog box 802 that is used to add a server to the portal server host list according to one embodiment of the present invention. The dialog box 802 is displayed if the new button 420 of the cluster manager is pressed. The address of the server is entered in an address field 804. The port number of the server is entered in a port field 806. Thereafter, a save button 808 is pressed to save the entered information to the lock server and add the server to the portal server host list.

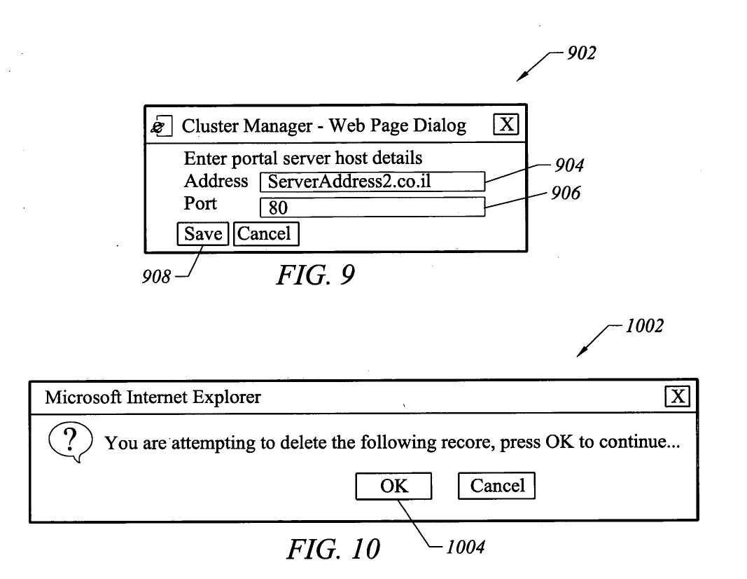

FIG. 9 illustrates a dialog box 902 that is used to modify the parameters of a server provided in the portal host server according to one embodiment of the present invention. The dialog box 902 is displayed if the edit button 416 of the portal cluster manager is pressed. Each server in the cluster manager is provided with its own edit button. Accordingly, the parameters of a given server is edited by pressing the edit button of that selected server. The address and port information of the selected server may be edited on address and port fields 904 and 906. A save button 908 is pressed to save the changes to the cluster group table in the lock server.

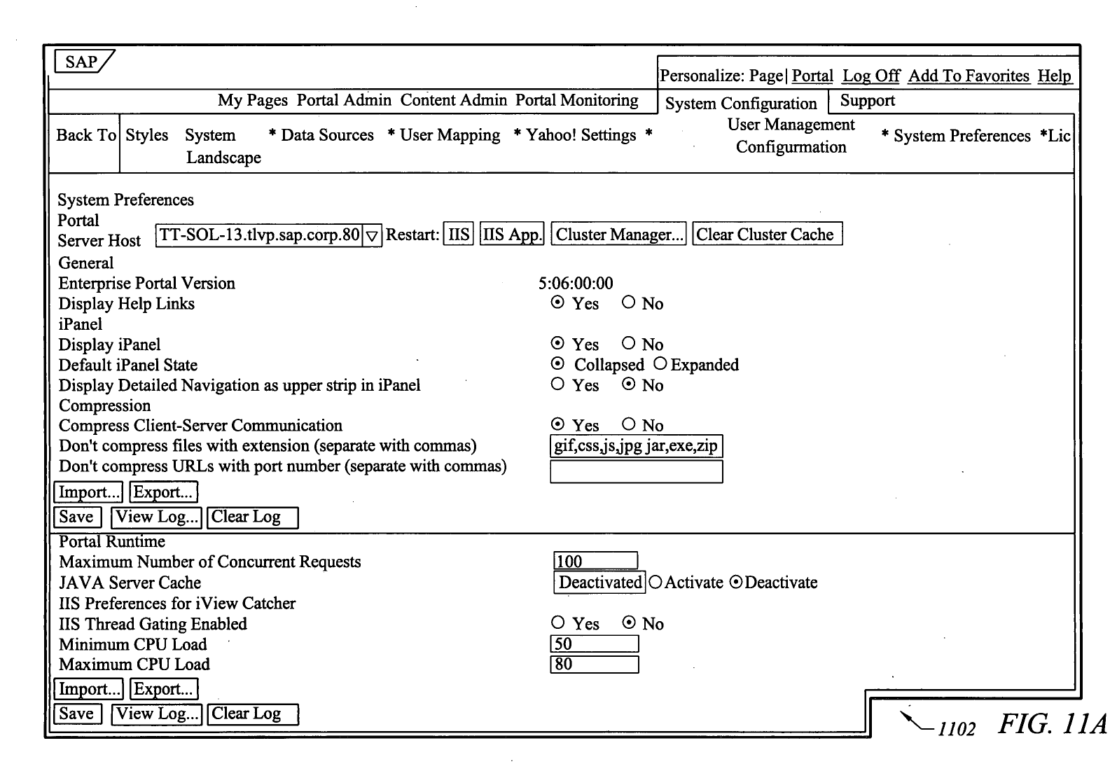

FIG. 10 illustrates a screen 1002 that is used to remove a server from the portal server host list according to one embodiment of the present invention. The screen 1002 is displayed if the delete button 418 is pressed. Each server in the cluster manager is provided with its own delete button. Accordingly, any server may be removed from the list by pressing the delete button for that server. The server is removed from the list once an OK button 1004 is pressed to confirm the selection to remove the server. The server is removed from the cluster group table, so that the removed server would no longer appear in the portal server host list thereafter.

The present invention has been illustrated using specific embodiments above. The above embodiments may be amended, modified, or altered without departing from the scope of the invention. Accordingly, the scope of the invention is defined by the appended claims.

1. A method for managing a plurality of servers, the method comprising:
launching a cluster manger in response to a request from a user, the cluster manager being operable to manage system preference settings of a plurality of servers in a cluster group;
selecting a first server from the plurality of servers provided in the cluster group according to an input from the user, the selected first server being designated to be a master server;
receiving a new system preference setting for the first server from the user;
selecting a second server from the plurality of server provided in the cluster group according to an input from the user; and
synchronizing a system preference setting of the second server to the new system preference setting of the first server according to an input from the user.

2. The method of claim 1, further comprising:
applying the new system preference setting to the first server according to an input from the user.

3. The method of claim 1, wherein the input to apply the new system preference setting to the first server is initiated by pressing of an apply button assigned to the first server by the user.

4. The method of claim 1, wherein the input to synchronize the second server to the new system preference setting of the first server is initiated by pressing of a synchronize button assigned to the second server, the synchronize button being provided on a first user interface page of the cluster manager.

5. The method of claim 4, further comprising:
applying the synchronized system preference setting of the second server to the second server by restarting the second server.

6. The method of claim 5, wherein the input to restart the second server is initiated by pressing a restart button assigned to the second server, the restart button being provided on the first user interface page of the cluster manager.

7. The method of claim 1, further comprising:
accessing a cluster group table stored in a server associated with the cluster group, the table including a list of the plurality of servers in the cluster group, the table further including address and port information of each of the plurality of servers.

8. The method of claim 7, wherein the first interface page is generated by using the table.

9. The method of claim 1, wherein the selected first server may be any one of the plurality of servers.

10. The method of claim 1, wherein the selected first server is the master server for a first session.

11. The method of claim 10, further comprising:
selecting a third server in the plurality of servers in the cluster group to be a master server for a second session, the second session being a different session than the first session.

12. A method for managing a plurality of servers in a portal environment, the method comprising:
selecting a first server from the plurality of servers provided in a cluster group, the selected first server being designated to be a master server;
changing a system preference setting of the first server, the changed system preference setting being a new system preference setting for the first server;
selecting a second server from the plurality of server provided in the cluster group;
synchronizing a system preference setting of the second server to the new system preference setting of the first server; and
applying the synchronized system preference setting to the second server.

13. The method of claim 12, wherein the synchronizing and applying steps are initiated by pressing first and second buttons displayed on a main user interface page of a cluster manager.

14. The method of claim 13, wherein the first and second buttons are different buttons.

15. A computer system having a plurality of servers, the computer system comprising:
means for launching a cluster manger in response to a request from a user, the cluster manager being operable to manage system preference settings of a plurality of servers in a cluster group;
means for selecting a first server from the plurality of servers provided in the cluster group according to an input from the user, the selected first server being designated to be a master server;
means for receiving a new system preference setting for the first server from the user;
means for selecting a second server from the plurality of server provided in the cluster group according to an input from the user; and
means for synchronizing a system preference setting of the second server to the new system preference setting of the first server according to an input from the user.

16. A computer readable medium including a computer program operable to manage system preference settings of a plurality of server provided in a cluster group, the computer program including:
code for selecting a first server from the plurality of servers provided in the cluster group according to an input from a user, the selected first server being designated to be a master server;
code for receiving a new system preference setting for the first server from the user;
code for selecting a second server from the plurality of server provided in the cluster group according to an input from the user; and
code for synchronizing a system preference setting of the second server to the new system preference setting of the first server according to an input from the user.
